(19) United States
(12) Patent Application Publication
(10) Pub. No.: US 2007/0133944 A1
(43) Pub. Date: Jun. 14, 2007

(54) INFORMATION PROCESSING APPARATUS, INFORMATION RECORDING MEDIUM MANUFACTURING APPARATUS, INFORMATION RECORDING MEDIUM, METHOD, AND COMPUTER PROGRAM

(75) Inventors: Yoshikazu Takashima, Tokyo (JP); Masahisa Shiki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Minato-Ku (JP)

(21) Appl. No.: 11/563,100

(22) Filed: Nov. 24, 2006

(30) Foreign Application Priority Data
Dec. 8, 2005 (JP) 2005-355242

(51) Int. Cl. H04N 5/91

(52) U.S. Cl. 386/94

(57) ABSTRACT

An information processing apparatus includes a control unit and a memory. The control unit obtains a content playback application program, recorded on an information recording medium, corresponding to content recorded on the information recording medium, and performs a content playback operation according to the obtained content playback application program. The memory stores a region code specific to a region corresponding to the information processing apparatus. The control unit executes a region code check program that is contained in the content playback application program to determine whether or not utilization of the content is permitted based on the region code corresponding to the information processing apparatus. The control unit performs the content playback operation using the content playback application program if the information processing apparatus is confirmed as the apparatus compliant with the region where the utilization of the content is permitted.

### CROSS REFERENCES TO RELATED APPLICATIONS

The present invention contains subject matter related to Japanese Patent Application JP 2005-355242 filed in the Japanese Patent Office on Dec. 8, 2005, the entire contents of which are incorporated herein by reference.

### BACKGROUND OF THE INVENTION

1. Field of the Invention

The present invention relates to information processing apparatuses, information recording medium manufacturing apparatuses, information recording media, methods, and computer programs. More particularly, the present invention relates to an information processing apparatus, an information recording medium manufacturing apparatus, an information recording medium, a method, and a computer program that permit utilization of content recorded on an information recording medium, such as, for example, a DVD (Digital Versatile Disc), according to region information.

2. Description of the Related Art

Audio data such as music, video data such as movies, and various software data such as game programs and various application programs (hereinafter, collectively referred to as “content”) can be recorded on recording media as digital data. Kinds of recording media include, for example, a Blu-ray Disc® that employs a blue laser for writing data, a DVD (Digital Versatile Disc), an MD (Mini Disc), and a CD (Compact Disc). Particularly, Blu-ray Discs employing a blue laser for writing data are capable of storing high density data, thus being capable of storing high definition data such as mass video content.

Digital content is recorded on various information recording media, and provided to users. The users, in turn, play back or utilize the content with PCs (Personal Computers) and playback apparatuses, such as disc players.

Generally, creators or distributors have distribution rights for most of the content, such as audio data and video data. When distributing the content, predetermined restriction is set for utilization of the content. More specifically, only authorized users have permission to utilize the content, such that unauthorized duplication is prevented.

Digital recording apparatuses and recording media allow repetition of recording and playback of content without decreasing the qualities of video and audio content, for example. This has unfortunately led to distribution of illegally copied content via the Internet and so-called pirated discs and utilization of copied content stored in hard disks of PCs or the like. The pirated discs may be CD-R (Compact Disc-Recordable) discs or the like on which content is illegally copied.

A mass recording medium is capable of holding mass data equivalent to, for example, one or more movies, as digital information thereon. The mass recording medium may be, for example, a DVD or a recording medium that has recently been developed and that employs a blue laser for writing data. Since recording of video information as digital information has been realized, it has become more important to take measures to prevent illegal copying and to protect the rights of copyright holders. Recently, various techniques have been employed in digital recording apparatuses and recording media in order to prevent illegal copying of such digital content.

Additionally, DVD systems employ a region code that allows restriction of regions where utilization of content is permitted. For example, a region code unique to a region where the utilization of the content is permitted is recorded on discs holding the content. On the other hand, information processing apparatuses (e.g., players), which load the discs and play back the content, store a region code corresponding to a region where the apparatuses are sold.

The information processing apparatuses (e.g., players) read out the region code recorded on the discs before playing back the content. The information processing apparatuses (e.g., players) then determine whether or not the read out region code matches the region code stored therein. Only when the region codes match and the apparatuses are confirmed as the ones compliant with the authorized region, the information processing apparatuses can utilize the content.

However, known information processing apparatuses that restrict content utilization using a region code generally store a fixed region code check program therein. Once the check program is falsified, region-restricted content can be undesirably played back with players that are not compliant with the authorized region. Content can be utilized illegally by the falsification of the check program.

Japanese Unexamined Patent Application Publication No. 2004-118830 discloses a configuration of recording content encrypted with a region code, which is unique to each region, on a disc. Such content encryption prevents the content from being played back in regions other than the authorized region. More specifically, when creating multi-regional content, the content has to be encrypted with different region codes and a plurality of encrypted content has to be recorded on a disc. In addition, when content is attached with a time-limited utilization restriction, the above-described encryption configuration may not realize such time-limited utilization restriction. Accordingly, flexible configurations may not be realized. In addition, since this configuration uses part of the region code as an encryption key, it is necessary not only to prevent the region code from being falsified but also to hold the region code confidentially.

### SUMMARY OF THE INVENTION

Embodiments of the present invention are made in view of such circumstances. An information processing apparatus, which plays back content, realizes content utilization control for permitting utilization of the content recorded on an information recording medium, such as, for example, a DVD (Digital Versatile Disc) according to regions. Such an information processing apparatus does not store a fixed region code check program. The region code check programs are included in playback programs corresponding to the content recorded on the information recording medium. This allows various program settings to be attached to each content. This also prevents the region code checking operation performed on other content from being affected by the leakage of a check program corresponding to one content. In addition, embodiments of the present invention provide an information processing apparatus capable of performing a region code checking operation that allows various content utilization control, such as permission of content utilization in a plurality of regions and permission of time-limited content utilization, to be performed on the content. Embodiments of the present invention also provide an information recording medium manufacturing apparatus, an information recording medium, methods, and a computer program.

According to an aspect of the present invention, an information processing apparatus includes a control unit for obtaining a content playback application program, recorded on an information recording medium, corresponding to content recorded on the information recording medium, and for performing a content playback operation according to the obtained content playback application program, and a memory for storing a region code specific to a region corresponding to the information processing apparatus. The control unit executes a region code check program that is contained in the content playback application program, determines whether or not utilization of the content to be played back using the content playback application program is permitted on the basis of the region code corresponding to the information processing apparatus and stored in the memory, and performs the content playback operation using the content playback application program if the information processing apparatus is confirmed as the apparatus compliant with the region where the utilization of the content is permitted.

In addition, in an information processing apparatus according to an embodiment of the present invention, the control unit may obtain a movie object recorded according to a Blu-ray Disc format as the content playback application program, and may execute the region code check program contained in the movie object.

Additionally, in an information processing apparatus according to another embodiment of the present invention, the control unit may obtain a Java® application program as the content playback application program, and may execute the region code check program contained in the obtained application program.

Furthermore, in an information processing apparatus according to still another embodiment of the present invention, the control unit may perform a signature verification operation on a digital signature attached to the content playback application program, and may execute the region code check program if validity of the content playback application program is confirmed in the signature verification operation.

Moreover, in an information processing apparatus according to a further embodiment of the present invention, the control unit may perform the signature verification operation on the digital signature attached to the content playback application program using a public key obtained from a public key certificate recorded on the information recording medium.

In addition, in an information processing apparatus according to a still further embodiment of the present invention, the control unit may determine whether or not the region code corresponding to the information processing apparatus stored in the memory matches a region code for a region where the utilization of the content is permitted with reference to a condition code for permitting content utilization included in condition information for permitting content utilization contained in the region code check program.

Additionally, in an information processing apparatus according to another embodiment of the present invention, the control unit may determine whether or not the utilization of the content is permitted on the basis of a time limitation condition for content utilization with reference to the time limitation condition for content utilization included in condition information for permitting content utilization contained in the region code check program.

According to another aspect of the present invention, an information recording medium manufacturing apparatus includes content file creating means for creating a content file holding content to be recorded on an information recording medium, content playback application file creating means for creating a content playback application file holding a content playback application program, and recording means for recording the content file created by the content file creating means and the content playback application file created by the content playback application file creating means on the information recording medium. The content playback application file creating means creates the content playback application file holding a region code check program that causes execution of a determination operation of whether or not utilization of the content is permitted on the basis of a region code that is specific to a region and stored in an information processing apparatus that performs a content playback operation.

In addition, in an information recording medium manufacturing apparatus according to another embodiment of the present invention, the content playback application file creating means may create the content playback application file to which a digital signature for falsification detection is attached.

According to still another aspect of the present invention, an information recording medium includes content and a content playback application program for causing a playback operation of the content to be performed. The content playback application program contains a region code check program for causing execution of a determination operation of whether or not utilization of the content is permitted on the basis of a region code that is specific to a region and stored in an information processing apparatus that performs a content playback operation.

In addition, in an information recording medium according to another embodiment of the present invention, the content playback application program may be attached with a digital signature for falsification detection.

Additionally, in an information recording medium according to still another embodiment of the present invention, the information recording medium may further includes a public key certificate containing a public key used as a digital signature verification key.

According to a further aspect of the present invention, an information processing method for an information processing apparatus that utilizes content recorded on an information recording medium includes the steps of obtaining a content playback application program that corresponds to the content recorded on the information recording medium and that is recorded on the information recording medium, determining, by executing a region code check program contained in the obtained content playback application program, whether or not utilization of the content to be played back using the content playback application program is permitted on the basis of a region code that is a region-specific code corresponding to the information processing apparatus and that is obtained from a memory included in the information processing apparatus, and performing a content playback operation using the content playback application program if the information processing apparatus is confirmed as the apparatus compliant with the region where the utilization of the content is permitted at the step of determining.

In addition, in an information processing method according to another embodiment of the present invention, the step of obtaining the program may include obtaining a movie object recorded according to a Blu-ray Disc format as the content playback application program. The step of determining may include executing the region code check program contained in the movie object.

Additionally, in an information processing method according to still another embodiment of the present invention, the step of obtaining the program may include obtaining a Java® application program as the content playback application program. The step of determining may include executing the region code check program contained in the obtained application program.

Furthermore, in an information processing method according to a further embodiment of the present invention, the information processing method may further include the step of performing a signature verification operation on a digital signature attached to the content playback application program so as to confirm the validity of the content playback application program in the signature verification operation. The step of determining may include executing the region code check program if the validity of the content playback application program is confirmed in the signature verification operation.

Moreover, in an information processing method according to a still further embodiment of the present invention, the step of performing the signature verification operation may include performing the signature verification operation on the digital signature attached to the content playback application program using a public key obtained from a public key certificate recorded on the information recording medium.

In addition, in an information processing method according to another embodiment of the present invention, the step of determining may include determining whether or not the region code corresponding to the information processing apparatus matches a region code for a region where the utilization of the content is permitted with reference to a condition code for permitting content utilization included in condition information for permitting content utilization contained in the region code check program.

Additionally, in an information processing method according to still another embodiment of the present invention, the step of determining may include determining whether or not the utilization of the content is permitted on the basis of a time limitation condition for content utilization with reference to the time limitation condition for content utilization included in condition information for permitting content utilization contained in the region code check program.

According to a still further aspect of the present invention, an information recording medium manufacturing method includes the steps of creating a content file holding content to be recorded on an information recording medium, creating a content playback application file holding a content playback application program, and recording the content file created at the step of creating the content file and the content playback application file created at the step of creating the content playback application file on the information recording medium. The step of creating the content playback application file includes creating the content playback application file holding a region code check program that causes execution of a determination operation of whether or not utilization of the content is permitted on the basis of a region code that is a region-specific code stored in an information processing apparatus that performs a content playback operation.

In addition, in an information recording medium manufacturing method according to another embodiment of the present invention, the step of creating the content playback application file may include creating the content playback application file to which a digital signature for falsification detection is attached.

According to another aspect of the present invention, a computer program causes an information processing apparatus to perform a utilization process of content recorded on an information recording medium. The process includes the steps of obtaining a content playback application program that corresponds to the content recorded on the information recording medium and that is recorded on the information recording medium, determining, by executing a region code check program contained in the obtained content playback application program, whether or not utilization of the content to be played back using the content playback application program is permitted on the basis of a region code that is a region-specific code corresponding to the information processing apparatus and that is obtained from a memory included in the information processing apparatus, and performing a content playback operation using the content playback application program if the information processing apparatus is confirmed as the apparatus compliant with the region where the utilization of the content is permitted at the step of determining.

The computer program according to an embodiment of the present invention may be provided to, for example, a computer system capable of executing various program codes as a computer-readable recording medium or via a communication medium. Types of the recording medium include a DVD (Digital Versatile Disc), a CD (Compact Disc), and an MO (Magneto-Optical) disc. The communication medium may be a network. By providing such a program in a computer-readable manner, the computer system can realize processing according to the program.

Further objects, features and advantages of the present invention will become clear from the detailed description of embodiments of the present invention and the accompanying drawings given below. In addition, herein, a term “system” indicates a logical set of a plurality of apparatuses, and each apparatus is not necessarily included in one housing.

According to an embodiment of the present invention, an information processing apparatus, which plays back content, realizes content utilization control for permitting utilization of content recorded on an information recording medium, such as, for example, a DVD (Digital Versatile Disc) according to regions. Such an information processing apparatus does not store a fixed region code check program. The region code check programs are included in playback programs corresponding to the content recorded on the information recording medium. This allows various program settings to be attached to each content. This also prevents the region code checking operation performed on other content from being affected by the leakage of a check program corresponding to one content. In addition, inclusion of region code check programs in the playback programs corresponding to the content allows content utilization control to be performed on each content in various manners. For example, multi-regional content utilization permission or time-limited content utilization permission may be attached to the content.

### BRIEF DESCRIPTION OF THE DRAWINGS

FIG. 1 is a diagram illustrating a structure of data recorded on an information recording medium;

FIG. 2 is a diagram illustrating a detailed structure of data recorded on an information recording medium;

FIG. 3 is a diagram illustrating a directory structure of data recorded on an information recording medium;

FIG. 4 is a diagram illustrating a structure of a BDMV directory including data recorded on an information recording medium;

FIG. 5 is a diagram illustrating structures of AACS and CERTIFICATE directories including data recorded on an information recording medium;

FIG. 6 is a diagram illustrating a data structure of a content certificate;

FIG. 7 is a diagram illustrating details of a root certificate;

FIG. 8 is a diagram illustrating a correspondence between a content certificate and a root certificate;

FIG. 9 is a diagram illustrating an example of a content playback control operation including a region code checking operation performed by an information processing apparatus;

FIG. 10 is a diagram illustrating an example of a region code check program;

FIG. 11 is a diagram illustrating a structure of application layers employed by an information processing apparatus;

FIG. 12 is a flowchart illustrating a procedure of a content utilization operation performed by an information processing apparatus;

FIG. 13 is a diagram illustrating an example of a configuration of an information processing apparatus that loads an information recording medium and plays back or records data; and

FIG. 14 is a block diagram illustrating an example configuration of an information recording medium manufacturing apparatus.

### DESCRIPTION OF THE PREFERRED EMBODIMENTS

Detailed descriptions will be given below of an information processing apparatus, an information recording medium manufacturing apparatus, an information recording medium, a method, and a computer program according to embodiments of the present invention with reference to the accompanying drawings. The descriptions are given according to the following items.
1. Data Recorded on Information Recording Medium and Outline of Content Playback Operation
2. Details of Region Code Checking Operation
3. Example of Configuration of Information Processing Apparatus
4. Information Recording Medium Manufacturing Apparatus and Information Recording Medium
   1. Data Recorded on Information Recording Medium and Outline of Content Playback Operation

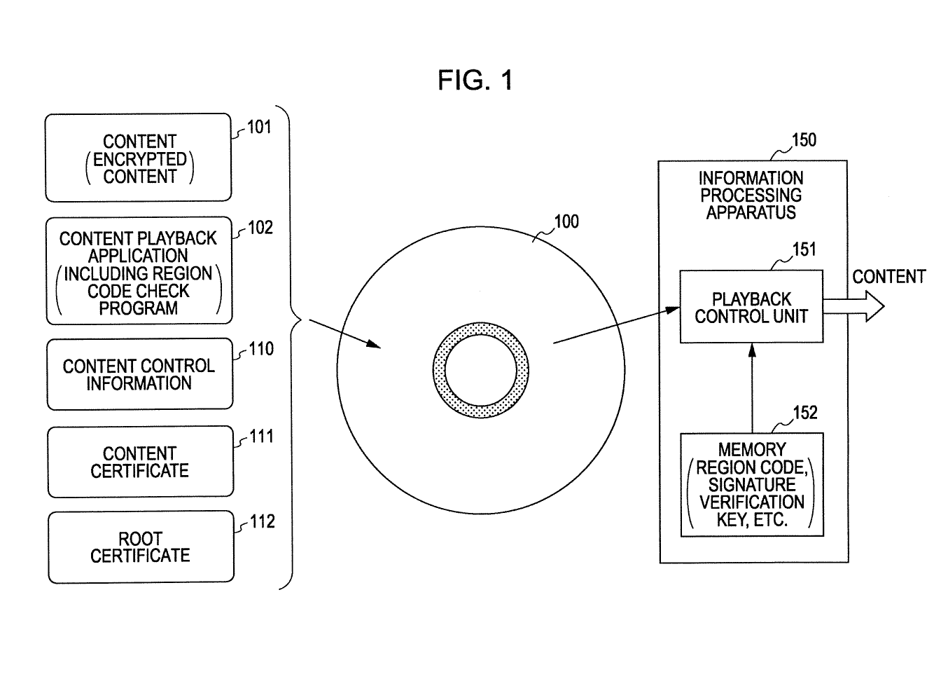

Now, referring to FIGS. 1 to 8, data recorded on an information recording medium and an outline of processing performed by an information processing apparatus for playing back content recorded on the information recording medium will be described. FIG. 1 shows an example of an information recording medium 100 having content recorded thereon. The processing according to an embodiment of the present invention can be performed on the content. This example shows information recorded on a ROM (Read Only Memory) disc, i.e., a disc having stored content.

The ROM disc is an information recording medium, such as, for example, a Blu-ray Disc or a DVD (Digital Versatile Disc). In addition, the ROM disc is an information recording medium manufactured at a disc manufacturing factory under a license of a so-called content rights holder and having authorized content recorded thereon. The content rights holder has legitimate copyrights or distribution rights of the content. Although the following embodiments take a disc medium as an example of the information recording medium, embodiments of the present invention can employ various types of information recording medium.

As shown in FIG. 1, the information recording medium 100 stores content 101. Types of the content 101 include AV (Audio Visual) streams of HD (High Definition) movie content, game programs, images, audio data, and text data compliant with specific standards.

Region restrictions are attached to at least part of the content (i.e., region-restricted content). When utilizing or playing back the region-restricted content, an information processing apparatus performs a region code checking operation.

More specifically, the information processing apparatus performs the region code checking operation in order to determine whether or not the information processing apparatus is provided (i.e., sold) in a region where the utilization of the content is permitted. If the information processing apparatus is confirmed by the region code checking operation as an apparatus provided in the region where the content utilization is permitted, the information processing apparatus can advance the process to a content utilization operation. The region code checking operation is performed on at least one of hardware of the information processing apparatus and software, i.e., playback application programs, for causing the information processing apparatus to perform a playback operation. A memory in the information processing apparatus stores the region code set for the hardware or the software. Although, in the description below, the region code is set for the information processing apparatus, the region code may be set for at least one of the hardware and the software.

A fixed region code check program has been prestored in the information processing apparatus. The same check program is used for performing the region code checking operation on the various region-restricted content. As shown in FIG. 1, according to an embodiment of the present invention, a content playback application 102 allowing playback of content includes the region code check program. That is, the region code check program is recorded on the information recording medium 100. To utilize the content 101, the information processing apparatus, which utilizes and plays back the content, reads out the content playback application 102 corresponding to the content, and performs the playback operation of the content according to the application.

Accordingly, including the region code check program in the playback program corresponding to the content recorded on the information recording medium allows each content to have a specific program set therefor. Even if the check program corresponding to one content is leaked out, the leakage does not affect the region code checking operation of other content. In addition, inclusion of the check program allows a content utilization control operation to be performed for each content in various manners. For example, various settings can be attached to each content. More specifically, multi-regional content utilization permission or time-limited content utilization permission may be attached to the content.

If the content 101 is region-restricted content, the content playback application 102 includes the region code check program. When playing back the content, the information processing apparatus reads out and executes the content playback application 102 corresponding to the content. Before performing the content playback operation, the information processing apparatus executes the region code check program included in the content playback application 102, and determines whether or not the information processing apparatus is an apparatus corresponding to the region where the content utilization is permitted. This determination operation will be described in detail below.

The information recording medium 100 also holds content control information (CCI) 110. The CCI 110 includes copy control information and playback control information set for the content 101. When utilizing the content 101, the information processing apparatus obtains the CCI 110 set for the content, and utilizes the content according to the control information included in the CCI.

The information recording medium 100 further holds a content certificate 111 for the content 101. The content certificate 111 contains data, for example, a hash value, generated on the basis of the content data. This data is used for confirming validity of the content.

Additionally, the information recording medium 100 holds a root certificate 112, which is, for example, a public key certificate. The root certificate 112 contains a public key used for the verification of a signature set for the content 101, the content playback application 102, or the region code check program.

The information processing apparatus 150 for playing back and utilizing the content recorded on the information recording medium 100 includes a playback control unit 151. The playback control unit 151 reads out the content playback application 102 recorded on the information recording medium 100, and performs a playback operation of the content 101 according to the content playback application 102. Before performing the content playback operation, the playback control unit 151 executes the region code check program included in the content playback application 102 so as to check the region code, when the content 101 to be utilized is region-restricted content.

Before performing the region code checking operation, the playback control unit 151 of the information processing apparatus 150 verifies a digital signature attached to the region code check program or the playback application using a signature verification key or a public key so as to confirm that the region code check program or the playback application is falsification-free valid data. The signature verification key (i.e., a public key) may be stored in a memory 152 of the information processing apparatus 150. Alternatively, the public key may be obtained from a public key certificate (e.g., the root certificate) recorded on the information recording medium 100. After the verification, the playback control unit 151 executes the region code check program included in the content playback application 102 so as to perform the region code checking operation. During the checking operation, the playback control unit 151 reads out the region code stored in the memory 152 of the information processing apparatus 150, i.e., the region code corresponding to the information processing apparatus (i.e., the hardware or the software). After confirming the permission of the content utilization by the region code checking operation, the playback control unit 151 advances the process to a content decryption operation and the content playback operation. These operations will be described in detail below.

Types of the content 101 recorded on the information recording medium 100 include, for example, AV (Audio Visual) streams of HD (High Definition) movie content, game programs, images, audio data, and text data compliant with specific standards. For example, if the information recording medium is a Blu-ray Disc, data compliant with the Blu-ray Disc ROM format is recorded on the disc as main contents. Here, data is recorded on the Blu-ray Disc with a blue laser that allows high-density recording.

Furthermore, service data having a format not compliant with a specific AV data format, such as game programs, image data, audio data, and text data, may be recorded as sub contents.

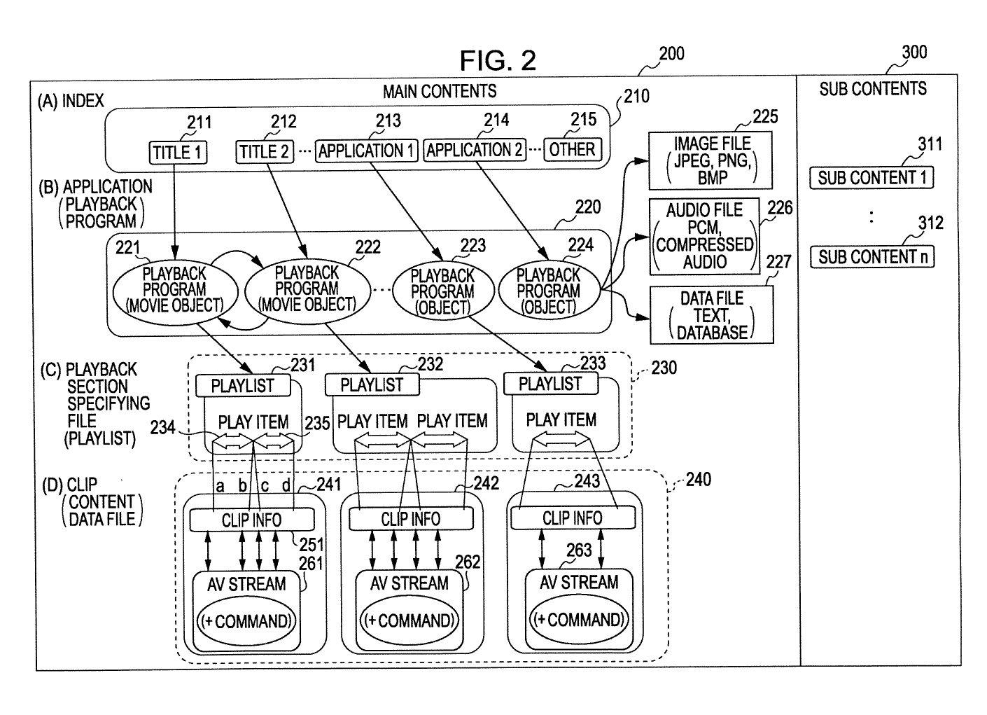

Referring to FIG. 2, an example recording format of content recorded on an information recording medium according to an embodiment of the present invention will be described. As shown in FIG. 2, AV stream files of HD (High Definition) movie content are recorded on the information recording medium as main contents 200. Other data and programs, such as image data and game programs constituted by, for example, Java applications, other image files, audio data, and text data are recorded as sub contents 300.

The main contents 200, i.e., data compliant with a specific AV format, for example, the Blu-ray Disc ROM format, are recorded according to the Blu-ray Disc ROM format. The sub contents 300, i.e., data not compliant with the Blu-ray Disc ROM format, are recorded according to a given format other than the Blu-ray Disc ROM format.

As shown in FIG. 2, the main contents 200 recorded according to the Blu-ray Disc ROM format include movie content (i.e., AV streams) data to be played back. The main contents 200 have a hierarchical structure specified in the Blu-ray Disc ROM format. More specifically, the main contents 200 have
(A) Index layer 210,
(B) Application layer 220,
(C) Playback section specification file layer (playlists) 230, and
(D) Clip layer (Content Data Files) 240.

The clip layer (i.e., content data files) 240 includes clip content data files 241, 242, and 243. The clip content data file 241 is independent and has an AV (Audio Visual) stream file 261 and a clip information file 251.

The clip information file 251 is a data file containing attribute information regarding the AV stream file 261. The AV stream file 261 is a data file of MPEG-TS (Moving Picture Experts Group-Transport Stream), and contains various data, such as video, audio, and subtitle data. In addition, command information for controlling the playback apparatus during the playback may be contained in the AV stream file 261.

The playback section specification file layer (i.e., playlists) 230 contains a plurality of playback section specification files (i.e., playlists) 231, 232, and 233. Each of the playback section specification files (i.e., playlists) 231, 232, and 233 contains one or more playitems. The playitem selects one of a plurality of AV stream files in the clips (i.e., the content data files) 240 and specifies a specific data section of the selected AV stream file with a playback start point (i.e., an IN-point) and a playback end point (i.e., an OUT-point). By selecting a playback section specification file (i.e., a playlist), a playback order of the content is determined according to the playitems contained in the selected playback section specification file (i.e., the playlist) and the corresponding content is played back.

The playitem 234 associated with the playback section specification file (i.e., the playlist) 231 specifies an IN-point “a” and an OUT-point “b” of the clip 241. In addition, the playitem 235 specifies an IN-point “c” and an OUT-point “d” of the clip 241. When the playback section specification file (i.e., the playlist) 231 is selected to trigger the playback of the content, specific data sections from “a” to “b” and from “c” to “d” of the AV stream file 261 included in the clip 241 is played back.

The application layer 220 contains playback programs used for playing back the content. The index layer 210 contains index information. The index information includes content titles to be displayed on a display on which played back content are shown. If a user selects one of the index information 221 to 215 displayed on the display, one of the playback programs 221 to 224 contained in the application layer 220 is invoked and executed.

As shown in FIG. 2, each title is associated with one of the playback programs (i.e., movie objects) 221 to 224. If the user selects one of the titles, the playback operation is started according to the playback program associated with the selected title.

The playback programs (i.e., movie objects) 221 to 224 are programs for content playback providing functions used for displaying content (i.e., the HD movie content) to be played back. These functions allow selection of the playback section specification file (i.e., the playlist), responses to user operations for content playback, skipping from one title to another, and modification of the playback order. Each of the playback programs 221 to 224 can invoke others. According to users input operations or predetermined programs, one of the playback programs 221 to 224 to be actually executed is selected. The content of the clip 240 is selected and played back according to the playback section specification file (i.e., the playlist) 230 specified by the selected playback program.

In addition, the playback programs 221 to 224 may have various application resource files, which may be obtained from an information recording medium or a server connected to a network. The resource files include, for example, an image file 225, an audio file 226, and a various data file 227. The image file 225 may be a JPEG (Joint Photographic Experts Group) file, a PNG (Portable Network Graphics) file, or a BMP (Bit MaP) file. The audio file 226 may be a PCM (Pulse Code Modulation) file or a compressed audio file. The data file 227 may be a text file or a database file.

If the content is region-restricted content, the playback programs (i.e., movie objects) 221 to 224 contained in the application layer 220 include the above-described region code check program.

Before performing the content playback operation, the playback control unit 151 of the information processing apparatus 150 shown in FIG. 1 reads out one of the playback programs (i.e., the movie objects) 221 to 224 from the information recording medium 100, and executes the program. If the content to be utilized is region-restricted content, the playback control unit 151 executes the region code check program included in the content playback application. If the information processing apparatus is confirmed by executing the region code check program as an apparatus corresponding to the region where the content utilization is permitted, the content is played back according to the playback program (i.e., the movie object). When the information processing apparatus is confirmed as an apparatus not corresponding to the region where the content utilization is permitted, playback of the content is canceled according to the playback program (i.e., the movie object).

The information recording medium also holds the sub contents 300 in addition to the main contents 200. The sub contents 300 are recorded according to a given format not compliant with a specific AV format, for example, the Blu-ray Disc ROM format.

The sub contents 300 may be video playback programs and game programs constituted by, for example, Java® applications, or may be other image files, audio data, and text data, and includes various sub contents 311 and 312.

The content playback application written in Java included in the sub contents may contain the region code check program if the content to be played back with the application is region-restricted content. The information processing apparatus configured to play back content executes the region code check program contained in the Java content playback application to determine whether or not the apparatus is compliant with the authorized region. If the apparatus is confirmed to be compliant with the authorized region, the content is played back.

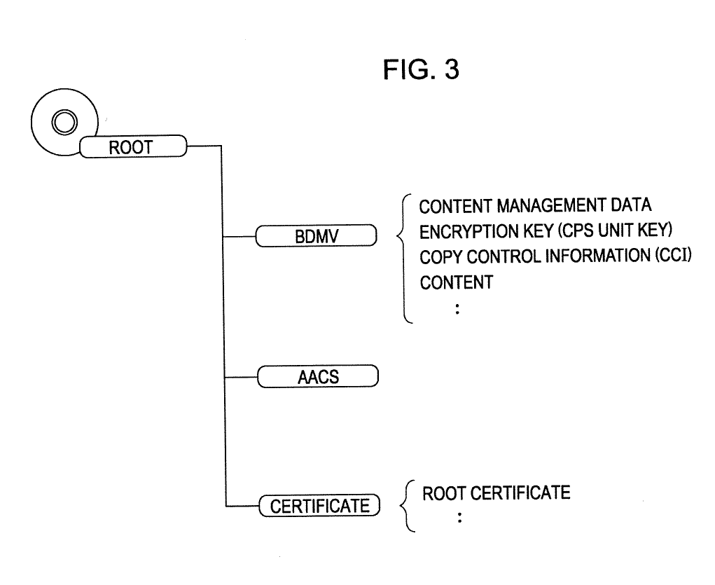

FIG. 3 shows a directory structure of data recorded on the information recording medium. The data recorded on the information recording medium is mainly classified into three directories, i.e., a BDMV directory, an AACS directory, and a CERTIFICATE directory. The BDMV directory includes content-related data such as content management data, encryption keys used for decryption of the content (i.e., CPS unit keys), copy protection information (CCI), and content. The AACS directory includes content certificates that prove the validity of the content supplied by the AACS (Advanced Access Content System). Additionally, the CERTIFICATE directory includes root certificates, i.e., public key certificates, containing public keys used for verifying signatures attached to Java application files included in the BDMV directory.

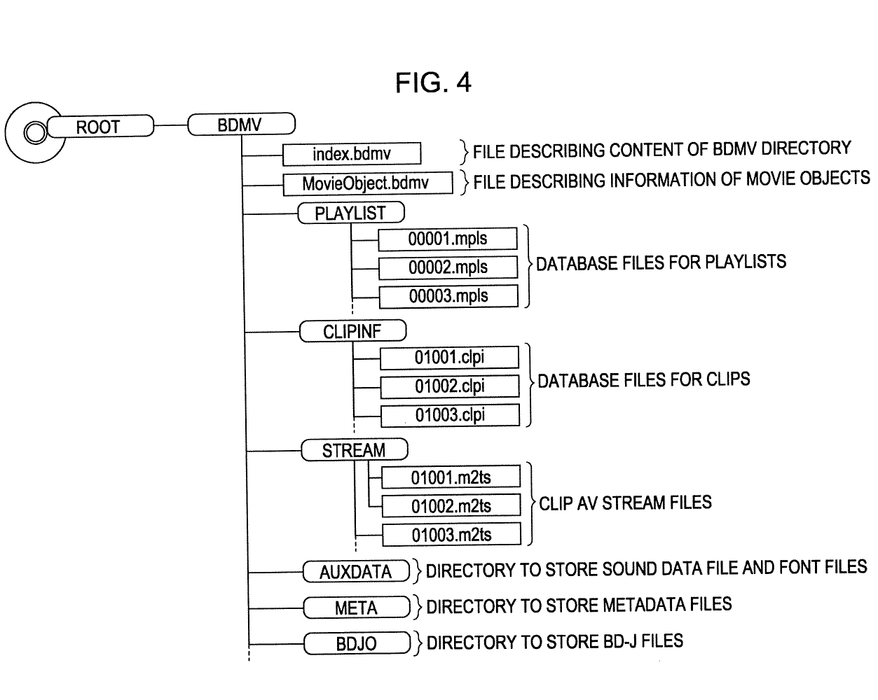

Referring to FIGS. 4 to 8, data included in each of the BDMV directory, the AACS directory, and the CERTIFICATE directory shown in FIG. 3 will be described in detail.

FIG. 4 shows details of the BDMV directory including content, etc. As described referring to FIG. 2, the BDMV directory has a hierarchical structure and includes individual files of the above-described index, movie object, playlists, and clips of the content. The index, movie object, playlist, and clip files are recorded according to the directory structure shown in FIG. 4. The files shown in FIGS. 2 and 4 have the following correspondence:
(A) The index 210 including the title 211 shown in FIG. 2 corresponds to an “index.bdmv” file included in the BDMV directory shown in FIG. 4;
(B) The application 220 including the playback programs (i.e., the movie objects) 221 to 224 shown in FIG. 2 corresponds to a “MovieObject.bdmv” file included in the BDMV directory shown in FIG. 4;
(C) The playlists 230 shown in FIG. 2 correspond to files under a “PLAYLIST” directory included in the BDMV directory shown in FIG. 4;
(D) The clips 240 shown in FIG. 2 correspond to files under a “CLIPINF” directory and files having the same number under a “STREAM” directory; and
(E) In addition to the above-described files, an “AUXDATA” file including audio data and font data, a “META” file including metadata, and a “BDJO” file including BD-Java objects such as Java applications are also recorded on the information recoding medium.

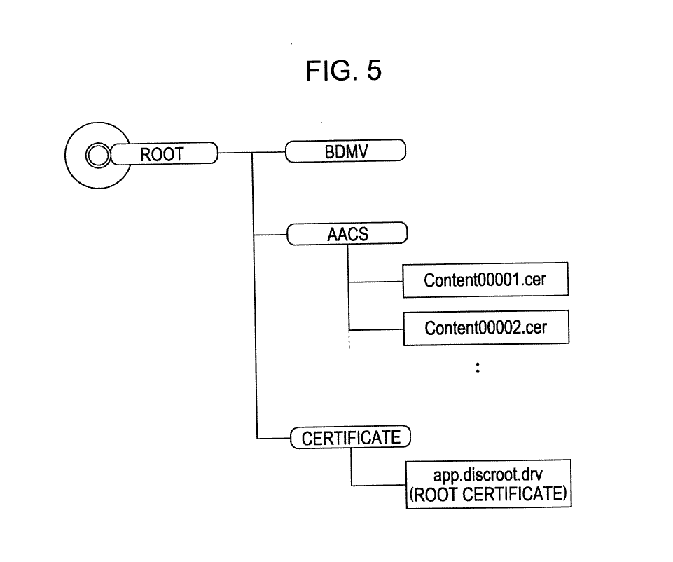

Now referring to FIGS. 5 to 8, the AACS directory, the CERTIFICATE directory, and data included in these directories will be described in detail. The AACS directory includes content certificates, supplied by the AACS (Advanced Access Content System), used for proving the validity of the content.

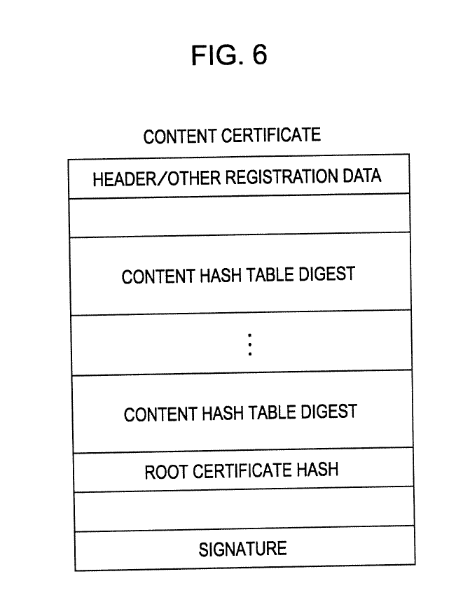

The content certificates are data allowing confirmation of the validity of the content included the BDMV directory. FIG. 6 shows a data structure of one of the content certificates. As shown in FIG. 6, the content certificate contains a header, a content hash table digest, a root certificate hash, and a signature. The header indicates that the data is the content certificate. The content hash table digest is a hash value of a table containing a hash value of part of content data. The root certificate hash is a hash value of a root certificate included in the CERTIFICATE directory. The signature is a signature of an issuer (e.g., a key management center) of the content certificate.

The hash value of the content hash table digest is used for content verification, such as detection of falsification of the content included in the BDMV directory. As mentioned before, the root certificate hash is a hash value of a root certificate included in the CERTIFICATE directory, and is a unique value corresponding to a specific root certificate. An application of this root certificate hash value will be described below.

Before executing processing referring to these hash values, a verification operation of the signature attached to the content certificate is performed so as to confirm that the content certificate itself has not been falsified. The content certificate may include a content provider ID, a content ID, a disc factory ID in addition to the above-described data.

The root certificate “app.discroot.drv” included in the CERTIFICATE directory is a public key certificate. The root certificate contains a public key used for verification of a signature attached to content, for example, a Java application file included in the BDMV directory, in order to detect the falsification of the file.

The public key contained in the root certificate is used not only for verification of the signature attached to the Java application file but also for verification of a signature attached to the movie objects. As mentioned above, the movie objects correspond to the content playback programs, in the application layer shown in FIG. 2. Before executing the region code check program included in these application programs, the signature verification is performed on the playback application (i.e., the movie object or the Java application) using the public key contained in the root certificate so as to confirm the validity of the playback application file.

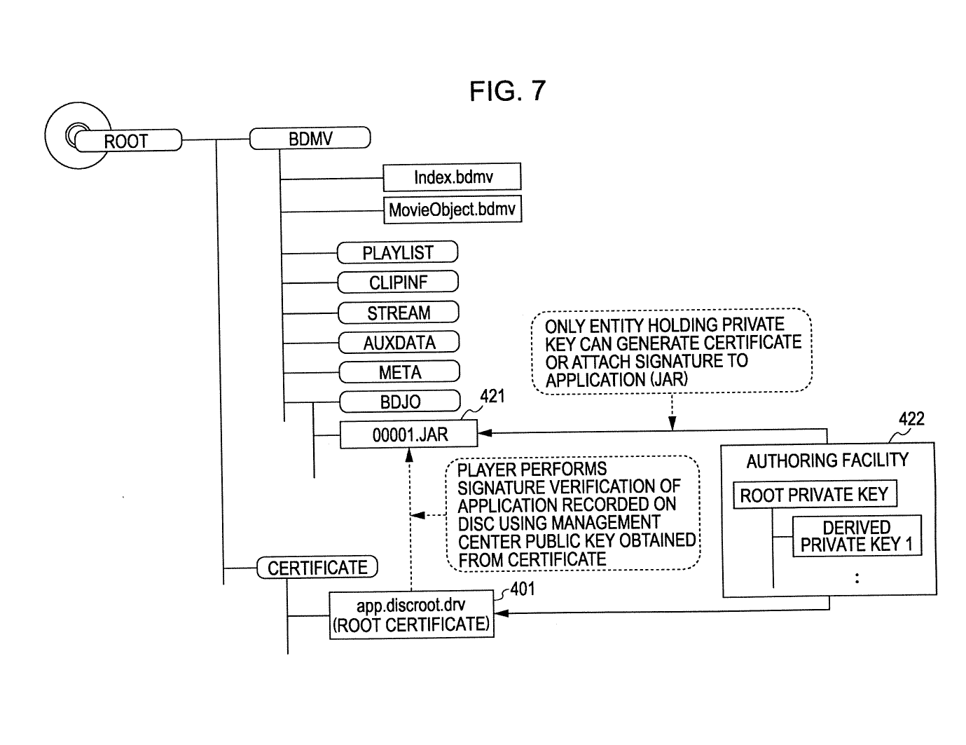

Now, referring to FIG. 7, the root certificate “app.discroot.drv” will be described in detail. FIG. 7 shows directories of standard content data recorded on the information recording medium. As described above, the information recording medium has the BDMV directory, the AACS directory, and the CERTIFICATE directory.

The CERTIFICATE directory includes a root certificate “app.discroot.drv” 401.

The root certificate “app.discroot.drv” 401 corresponds to a public key certificate containing a public key used for verification of a signature attached to content included in the BDMV directory, e.g., a Java application file “00001.JAR” 421. A signature is attached to the Java application file “00001.JAR” 421 using a private key of an authoring facility 422 shown in FIG. 7. Generally, an original private key of the authoring facility 422 is not directly used as the private key to attach the signature to the Java application file “00001.JAR” 421, and a derived private key generated on the basis of the private key used for attaching a signature to the root certificate 401 is used instead. The number of derivations of private keys may be limited to three, for example.

The root certificate “app.discroot.drv” 401, i.e., the public key certificate, contains the public key used for the verification of the signature of the Java application file “00001.JAR” 421.

The public key certificate contains the public key of the authoring facility 422 and various information, such as issue date information, expiration date information, and version information. Although there may be many public key certificates containing the same public key, each entire public key certificate data differs from one another, thus each public key certificate has unique information. Accordingly, the root certificate hash contained in the content certificate described referring to FIG. 6 is a unique value corresponding to a specific public key certificate.

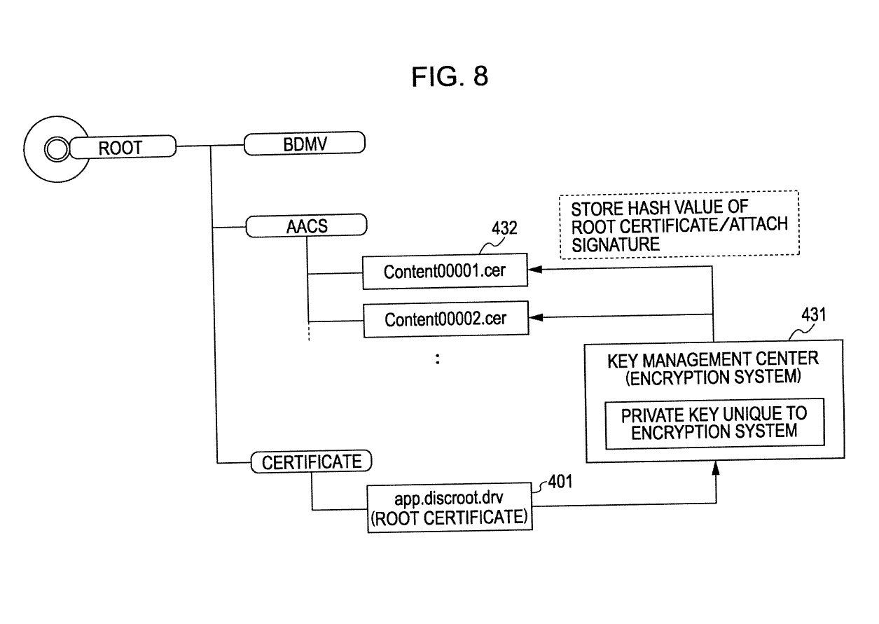

Now, referring to FIG. 8, a correspondence of data of a standard content recorded on an information recording medium (i.e., a recording medium such as a ROM disc), particularly, the correspondence between the root certificate and other data will be described.

FIG. 8 shows a correspondence between the content certificate described referring to FIG. 6 and the root certificate and generation of the root certificate. FIG. 8 shows directories of standard content recorded on the information recording medium such as a ROM. As described above, the information recording medium has the BDMV directory, the AACS directory, and the CERTIFICATE directory.

The CERTIFICATE directory includes the root certificate “app.discroot.drv” 401.

The root certificate 401 is a public key certificate containing a public key of the authoring facility 422 shown in FIG. 7. The root certificate 401 includes not only the public key but also the issue date information and the version number, and has unique information. That is, the root certificate 401 has different data according to each disc. A key management center 431 generates a hash value of the root certificate 401 including the unique data, and stores the hash value in the content certificate 432, which corresponds to the content recorded on the disc. The content certificate is set for each content recorded on the disc, i.e., each content included in the BDMV directory. When a plurality of content is recorded on the disc, the AACS directory includes a plurality of content certificates for the plurality of content. Each of the content certificates contains the hash value of the root certificate.

Accordingly, the content certificate has the hash value of the root certificate, which is stored after the processing performed by the key management center on the standard disc. This hash value is unique to each disc. For example, the hash value of the root certificate differs from that of a root certificate contained in a content certificate recorded on another disc.

2. Details of Region Code Checking Operation

Details of the region code checking operation will be described next. A region-restricted content is content permitted to be played back or utilized in a specific region, and is also referred to as “region code attached content”. When an information recording medium holds region code attached content, a region code checking operation is performed. As described above, the region code attached content is content permitted to be played back or utilized in a specific region. When the content recorded on the information recording medium is the region code attached content, an operation is performed in order to determine whether or not the content can be utilized on the basis of a region code stored in a memory of an information processing apparatus.

More specifically, whether or not the information processing apparatus is an apparatus compliant with the region where the content utilization is permitted is determined by checking the region code stored in the memory of the information processing apparatus. If the information processing apparatus is confirmed as an apparatus compliant with the authorized region by this checking operation, the information processing apparatus can utilize the content according to a content playback application program.

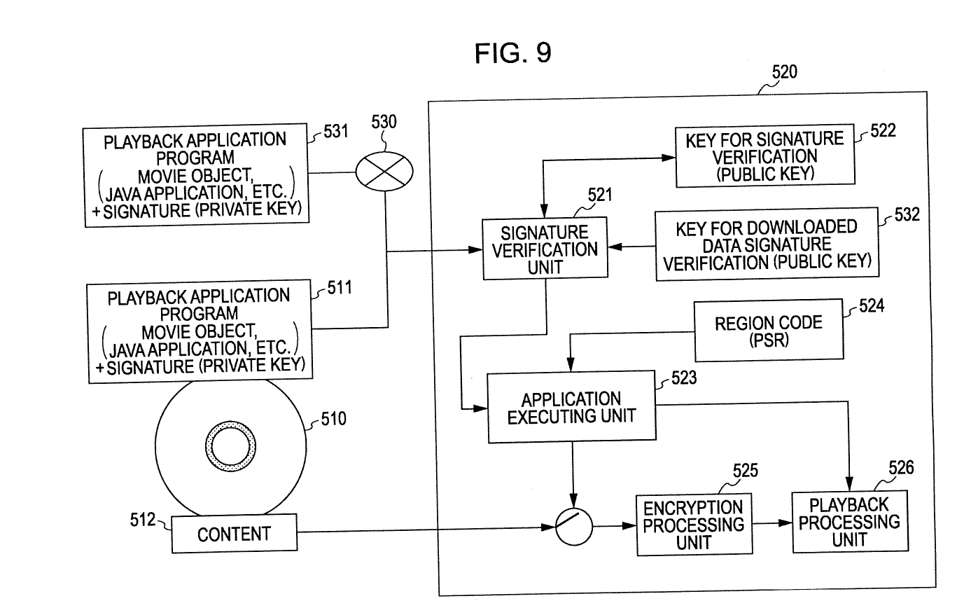

Referring to FIG. 9, a region code checking operation performed by an information processing apparatus according to an embodiment of the present invention will be described. As mentioned above, a playback application program 511 corresponding to content 512 recorded on an information recording medium 510 contains a region code check program. For example, as described referring to FIG. 2, the movie object, i.e., the playback application program, corresponding to the main contents includes the region code check program. In addition, if the playback application is a Java application, the Java application includes the region code check program. Both the movie object and the Java application are not necessary recorded on the information recording medium, and one of those may be recorded.

As described referring to FIG. 2, the playback application program, i.e., the movie object, corresponding to the main contents and the Java application may be obtained via a network 530. Referring to FIG. 9, a playback application program 531 obtained via the network 530 is shown separately. The playback application program 531 is, after obtained via the network 530, stored in a local storage, and can be utilized as a content playback application program for content recorded in the information recording medium 510. The local storage may be a hard disk.

A block diagram of the information processing apparatus 520 shown in FIG. 9 shows function blocks of the operation performed by the playback control unit 151 of the information processing apparatus 150 shown in FIG. 1. The information processing apparatus 520 obtains the playback application program 511 corresponding to content to be played back from an the information recording medium 510. Alternatively, the information processing apparatus 520 may obtain the playback application program 531 via the network 530.

A signature verification unit 521 of the information processing apparatus 520 verifies a signature attached to the obtained playback application. At this time, a signature verification key (i.e., a public key) 522 prestored in a memory of the information processing apparatus or a signature verification key for downloaded data (i.e., a public key) 532 are used. Alternatively, the signature verification unit 521 may verify the signature using a public key obtained from a public key certificate (e.g., the root certificate) recorded on the information recording medium 510. In addition, the signature verification unit 521 may use a signature verification key obtained via the network 530 so as to verify the digital signature attached to the playback application program 531, which is downloaded via the network 530. A manifest file is data retrieve information for the downloaded content. The manifest file may contain the signature verification key. The information processing apparatus 520 may obtain the manifest file, and the signature verification unit 521 of the information processing apparatus 520 may obtain the signature verification key from the manifest file so as to verify the signature.

The movie object recorded on the information recording medium 510 according to a format described above referring to FIG. 2 may not have a digital signature. When the digital signature is attached, the signature verification unit 521 verifies the signature. Otherwise, the signature verification unit 521 skips the signature verification performed on the movie object file obtained from the information recording medium 510. When the information processing apparatus 520 plays back the content 512 using the playback application program 531, i.e., the movie object, obtained via the network, the signature verification unit 521 verifies the digital signature attached to the downloaded playback application program 531.

If the signature verification unit 521 confirms that the playback application program 511 is the falsification-free valid playback application program by the signature verification operation of the playback application, an application executing unit 523 performs the region code checking operation according to the region code check program. As mentioned above, the region code check program is included in the playback application program 511.

The application executing unit 523 executes the region code check program included in the playback application program 511. During the region code checking operation, the application executing unit 523 reads out a region code 524 stored in the memory of the information processing apparatus 520. At this time, the region code 524 is read out using a register (i.e., PSR (Player Status Register)), which is a read out register of the application executing unit 523. The register (i.e., the PSR) holds a value representing a status of a player for performing the playback operation. The PSR is used by the application executing unit 523 as a read out register.

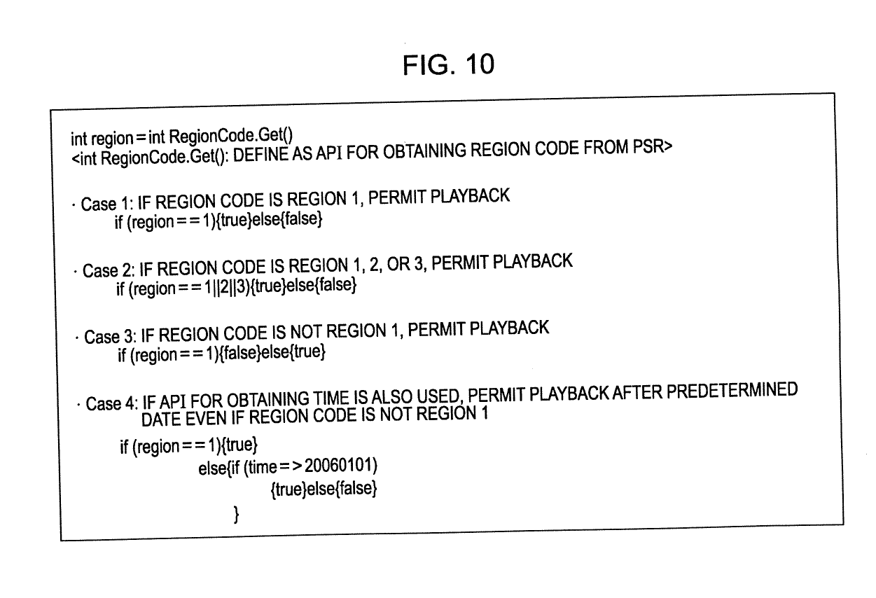

The region code check program contains information regarding conditions of content playback and utilization permission according to the region code stored in the information processing apparatus. Referring to FIG. 10, an example of a program code contained in the region code check program included in the playback application program 511 and permission condition information regarding content utilization will be described.

A program code “int region=int RegionCode.Get ( )” shown in FIG. 10 is an instruction code of obtaining the region code from the register (i.e., PSR) of the information processing apparatus. The information processing apparatus obtains the region code set therefor from the register (i.e., PSR) thereof.

The following “Cases 1 to 4” shows example permission condition information of content utilization contained in the region code check program included in the playback application program 511.

For example, Case 1 “if (region==1) {true} else {false}” is an example of setting a condition. In this example, if the region code obtained from the register (i.e., PSR) of the information processing apparatus is equal to 1, the playback is permitted. Otherwise, the playback is inhibited.

Case 2 “if (region==1| |2| |3) {true} else {false}” is an example of setting another condition. In this example, if the region code obtained from the register (i.e., PSR) of the information processing apparatus is equal to 1, 2, or 3, the playback is permitted. Otherwise, the playback is inhibited.

Case 3 “if (region==1) {false} else {true}” is an example of setting still another condition. In this example, if the region code obtained from the register (i.e., PSR) of the information processing apparatus is equal to 1, the playback is inhibited. Otherwise, the playback is permitted.

Case 4 “if (region==1) {true} else {if (time=>20060101) {true} else {false}}” is an example of setting a further condition. In this example, if the region code obtained from the register (i.e., PSR) of the information processing apparatus is equal to 1, the playback is permitted. If the region code is not equal to 1 and the current date is on and after Jan. 1, 2006, the playback is permitted.

Accordingly, the region code check program included in the playback application program corresponding to the content to be utilized may contain various permission conditions of content utilization. More specifically, the region code check program can contain various conditions of content utilization, such as a setting of permitting the content utilization if the region code stored in the information processing apparatus is a specific value, a setting of inhibiting the content utilization if the region code stored in the information processing apparatus is a specific value, or a setting of permitting the content utilization for a predetermined period if the region code is a specific value.

The application executing unit 523 shown in FIG. 9 first obtains the region code stored in the information processing apparatus. The application executing unit 523 then confirms the permission conditions of content utilization contained in the region code check program and determine whether or not the information processing apparatus is permitted to utilize the content. When the information processing apparatus is permitted to utilize the content, the application executing unit 523 reads out the content 512 from the information recording medium 510 according to a playback program included in the playback application program 511. An encryption processing unit 525 decrypts the content 512. A playback processing unit 526 then performs the playback operation.

On the other hand, if the application executing unit 523 shown in FIG. 9 executes the region code check program and determines that the information processing apparatus is not permitted to utilize the content, the playback operation of the content 512 according to the playback application program 511 is canceled. As mentioned above, the determination is made according to the permission conditions of content utilization contained in the region code check program.

Series of the playback permission determining operation based on the region code check program and content playback operation are performed on the content 512 according to the playback application program 511 recorded on the information recording medium 510.

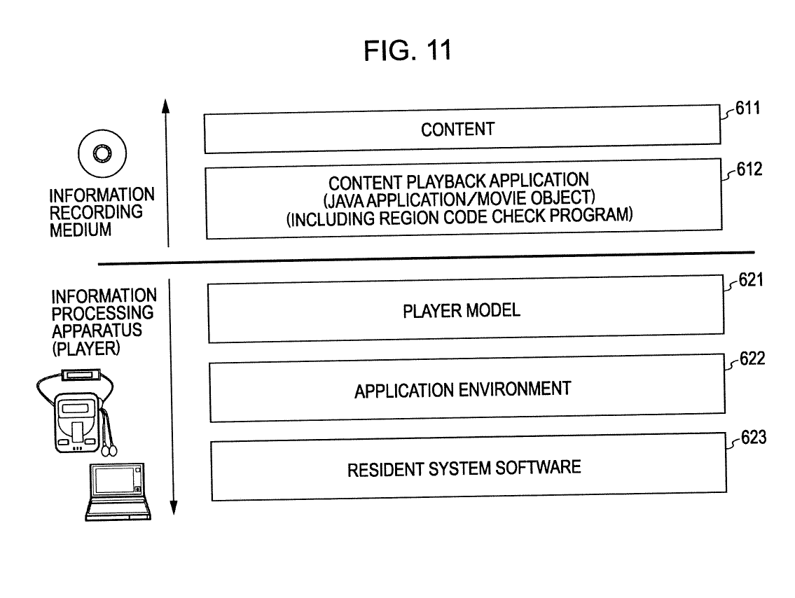

Now, referring to FIG. 11, a structure of application layers, employed by an information processing apparatus and relating to a region code checking operation performed by the playback control unit of the information processing apparatus, will be described. As shown in FIG. 11, the information recording medium holds content 611 and a content playback application (e.g., a Java application and a movie object) 612 corresponding to the content 611. The content playback application 612 contains a region code check program. As shown in FIG. 11, the information processing apparatus has three application layers, i.e., a player model layer 621, an application environment layer 622, and a resident system software layer 623.

The player model layer 621 plays back AV content and reads/writes data in a register (i.e., PSR). As mentioned above, the register may be a player status register (PSR). The PSR holds variables indicating a status of a player, for example, fixed information, such as information regarding codec that the information processing apparatus can handle, and information regarding playlist currently played back. The PSR also holds a region code.

Application environment layer 622 is a layer that executes applications set for the content to be played back. The application environment layer 622 includes a Java VM (Virtual Machine) that executes BD-J (Blu-ray Disc Java) applications and command processors that executes movie objects. During the execution, the BD-J applications and the movie objects can obtain playback environment information, such as values set in the PSR. The BD-J applications call APIs (Application Program Interfaces) to obtain specific values set in the PSR. The movie objects is capable of directly reading out the values set in the PSR.

The resident system software layer 623 is a layer that manages the upper two layers. For example, in response to an input operation from users, the resident system software layer 623 sends instructions to the player model layer 621 and switches titles currently played back according to the execution of applications.

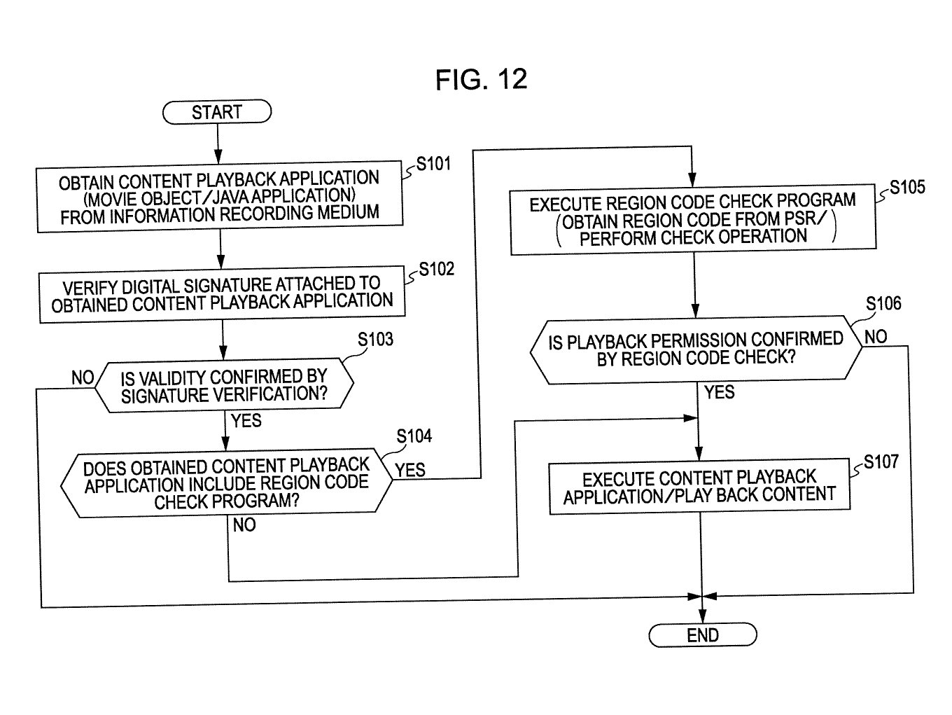

Now, referring to a flowchart shown in FIG. 12, a content playback operation performed by an information processing apparatus according to an embodiment of the preset invention will be described. At STEP S101, the information processing apparatus obtains the content playback application (e.g., the movie object or the Java application) from the information recording medium. At STEP S102, the information processing apparatus verifies a digital signature attached to the obtained content playback application. At this time, a signature verification public key stored in the information processing apparatus or a public key obtained from a public key certificate (e.g., a root certificate) recorded on the information recording medium is employed.

At STEP S103, if the application is determined, by the verification of the digital signature attached to the content playback application, to be falsified STEP S104 and the following steps are not performed, and the content playback operation is canceled. That is, the utilization or playback operation of the content is terminated.

At STEP S103, if the application is determined, by the verification of the digital signature attached to the content playback application, to be falsification-free valid data the process proceeds to STEP S104. At STEP S104, the information processing apparatus determines whether or not the obtained content playback application contains the region code check program. If the content playback application does not contain the region code check program, the content corresponding to the application is determined to be region-free content, and the process proceeds to STEP S107. At STEP S107, the information processing apparatus executes a playback program contained in the content playback application so as to play back the content.

On the other hand, at STEP S104, the information processing apparatus determines that the obtained content playback application contains the region code check program, the process proceeds to STEP S105. At STEP S105, the information processing apparatus executes the region code check program. More specifically, the information processing apparatus obtains the region code from the register (i.e., the PSR) so as to perform the region code checking operation. The region code check program includes the permission conditions for the content utilization described referring to FIG. 10, for example. The information processing apparatus determines whether or not the region code obtained from the register (i.e., the PSR) satisfies the permission conditions included in the region code check program.

At STEP S106, if the information processing apparatus determines, by the region code checking operation, that the playback of the content is permitted, the process proceeds to STEP S107. At STEP S107, the information processing apparatus executes the content playback application so as to play back the content. On the other hand, at STEP S106, if the information processing apparatus determines that the playback of the content is inhibited by the region code checking operation, STEP S107 is not performed, and the content playback operation is canceled. That is, the utilization or playback operation of the content is terminated.

Accordingly, the information processing apparatus according to the embodiment of the present invention performs the region code checking operation by executing the region code check program contained in the playback application corresponding to the content. Including the region code check program in the playback program corresponding to the content recorded on the information recording medium allows a specific program setting to be attached to each content. This prevents the region code checking operation performed on other content from being affected by the leakage of a check program corresponding to one content.

In addition, the playback application program corresponding to the content includes the region code check program. Various content utilization control can be performed for the content. For example, utilization permission can be granted to a plurality of regions, or time limitation can be attached to the utilization permission. Additionally, the playback application, containing the region code check program, is attached with a digital signature. The playback application is executed after the signature verification, which can prevent a wrong region code checking operation from being performed due to the unauthorized falsification. Furthermore, the region code check programs are executed as objects (e.g., movie objects or Java object (BDJO)) compliant with the Blu-ray Disc format. This allows players to efficiently confirm the region code without having extra loads.

3. Example of Configuration of Information Processing Apparatus

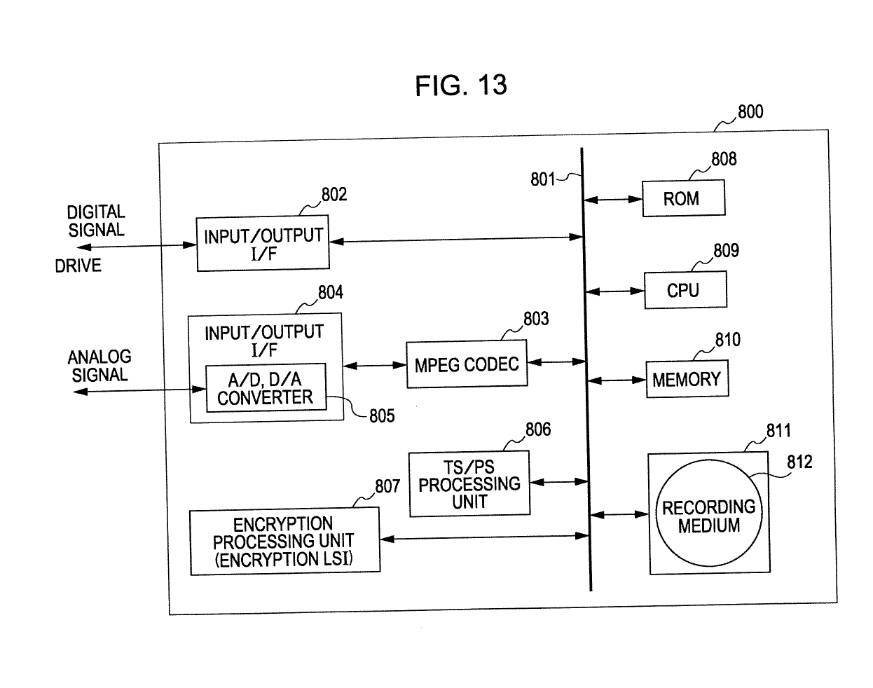

Now, referring to FIG. 13, an example of a configuration of an information processing apparatus that plays back content recorded on an information recording medium will be described. An information processing apparatus 800 includes a CPU (Central Processing Unit) 809, a ROM (Read Only Memory) 808, a memory 810, input/output interfaces (I/F) 802 and 804, an MPEG codec (Moving Picture Experts Group Encoder/Decoder) 803, a TS (Transport Stream)/PS (Program Stream) processing unit 806, an encryption processing unit 807, a recording medium 812, and a drive 811. Each unit is connected to a bus 801. The CPU 809 processes data according to an OS (Operating System) and various programs such as content playback application programs. The ROM 808 stores programs and parameters. The input/output I/F 802 enables input/output of digital signals. The input/output I/F 804 enables input/output of analog signals and includes A/D (Analog-to-Digital) and D/A (Digital-to-Analog) converter 805. The MPEG codec 803 encodes/decodes MPEG data. The TS/PS processing unit 806 processes TS (Transport Stream) data and PS (Program Stream) data. The encryption processing unit 807 performs various encryption/decryption operations such as signature verification and decryption of encrypted content. The recording medium 812 may be a hard disk. The drive 811 drives the recording medium 812, and inputs/outputs the data signal to be recorded or played back.

The information processing apparatus 800 is connected to a drive that drives an information recording medium via a bus, such as, for example, ATAPI (AT Attachment Packet Interface)-BUS. The input/output I/F for digital signals 802 enables the input/output of content and playback applications recorded on the information recording medium. The encryption processing unit 807 encrypts/decrypts data using an encryption algorithm, such as the AES (Advanced Encryption Standard) algorithm.

The ROM 808 stores programs for playing back or recording content. The information processing apparatus 800 uses the memory 810 as a working area for temporarily storing parameters and data if necessary while performing the processing. The ROM 808 or the recording medium 812 stores, for example, a public key for signature verification and a region code.

4. Information Recording Medium Manufacturing Apparatus and Information Recording Medium

Now, an information recording medium manufacturing apparatus and an information recording medium will be described. More specifically, apparatus and method for manufacturing an information recording medium employed in the above-described content playback operation and the information recording medium will be described.

The information recording medium manufacturing apparatus is an apparatus for manufacturing an information recording medium 100 having data recorded thereon described above with reference to FIG. 1, for example. The information recording medium 100 holds content and playback application programs containing region code check programs.

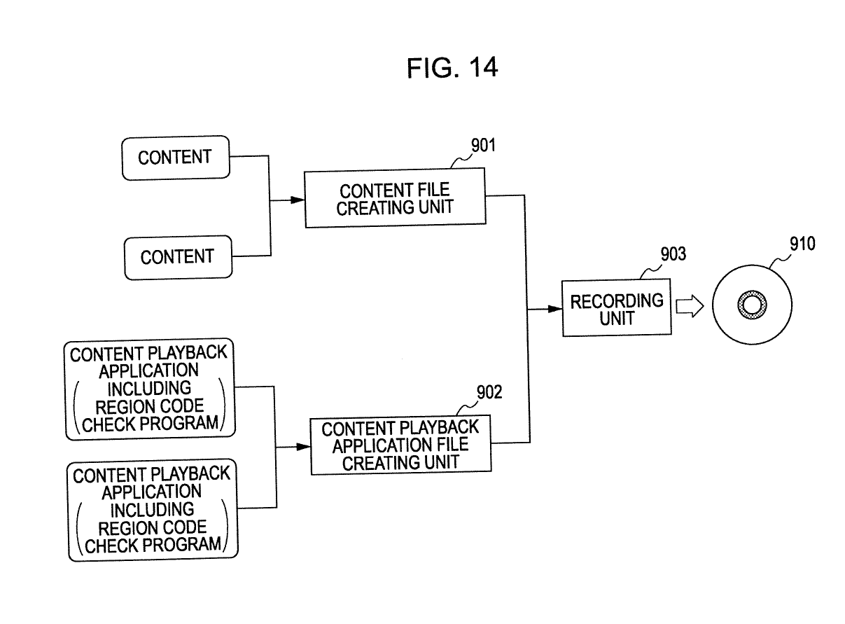

As shown in FIG. 14, the information recording medium manufacturing apparatus includes a content file creating unit 901, a content playback application file creating unit 902, and a recording unit 903. The content file creating unit 901 creates content files having content data to be recorded on the information recording medium. The content playback application file creating unit 902 creates content playback application files. The content playback application files contain region code check programs to be executed before utilizing the content. The recording unit 903 records the content files created by the content file creating unit 901 and the content playback application files created by the content playback application file creating unit 902 on an information recording medium 910.

The content playback application file creating unit 902 creates the content playback application files containing region code check programs. As described above with reference to FIG. 10, the region code check programs include region code information restricting authorized regions.

The information recording medium 910 manufactured by such an information recording medium manufacturing apparatus holds various data described with reference to FIG. 1. More specifically, the information recording medium 910 holds at least content files having content data and content playback applications containing region code check programs to be executed before utilization of the content.

The content playback application files to be recorded on the information recording medium includes region code check programs. As described above with reference to FIG. 10, the region code check programs include region code information restricting authorized regions.

In the above, the present invention has been described in detail with reference to specific embodiments. However, it is obvious that various modifications and applications may occur to those skilled in the art without departing from the spirit and scope of the invention. That is, embodiments described herein are only examples, and the preset invention is not limited to these particular embodiments. Claims should be considered to understand the spirit and scope of the present invention.

The series of steps described herein may be executed by hardware, software, or combination thereof. When the steps are executed by software, a program containing the steps may be installed in a memory of a computer embedded in a dedicated hardware and executed. Alternatively, the program may be installed in a general-purpose computer capable of performing various processing and executed.

For example, programs may be prestored in a recording medium, such as a hard disk and a ROM (Read Only Memory). Alternatively, programs may be temporarily or permanently stored in (recorded on) a removable recording medium, such as a flexible disk, a CD-ROM (Compact Disc Read Only Memory), an MO (Magneto-Optical) disc, a DVD (Digital Versatile Disc), a magnetic disk, and a semiconductor memory. Such a removable recording medium may be provided as so-called package software.

The programs may be installed in a computer from the above-described removable recording medium. Alternatively, the programs may be wirelessly transferred to a computer from a download site or may be transferred to a computer via a network, such as a LAN (Local Area Network) and the Internet. The computer may receive the transferred programs, and install the programs in a recording medium, such as a hard disk, included therein.

Various processing described herein may be executed sequentially in the described order or may be executed in parallel or individually according to a capability of an apparatus executing the processing. In addition, herein, a term “system” indicates a logical set of a plurality of apparatuses, and each apparatus is not necessarily included in one housing.

What is claimed is:

1. An information processing apparatus comprising:
a control unit for obtaining a content playback application program, recorded on an information recording medium, corresponding to content recorded on the information recording medium, and for performing a content playback operation according to the obtained content playback application program; and
a memory for storing a region code specific to a region corresponding to the information processing apparatus, wherein
the control unit executes a region code check program that is contained in the content playback application program and that has a program restricting at least a region where playback of the content is permitted, determines whether or not utilization of the content to be played back using the content playback application program is permitted on the basis of the region code corresponding to the information processing apparatus and stored in the memory, and performs the content playback operation using the content playback application program if the information processing apparatus is confirmed as the apparatus compliant with the region where the utilization of the content is permitted.

2. The apparatus according to claim 1, wherein the control unit obtains a movie object recorded according to a Blu-ray Disc format as the content playback application program, and executes the region code check program contained in the movie object.

3. The apparatus according to claim 1, wherein the control unit obtains a Java® application program as the content playback application program, and executes the region code check program contained in the obtained application program.

4. The apparatus according to claim 3, wherein the control unit performs a signature verification operation on a digital signature attached to the content playback application program, and executes the region code check program if validity of the content playback application program is confirmed in the signature verification operation.

5. The apparatus according to claim 4, wherein the control unit performs the signature verification operation on the digital signature attached to the content playback application program using a public key obtained from a public key certificate recorded on the information recording medium.

6. The apparatus according to claim 1, wherein the control unit determines whether or not the region code corresponding to the information processing apparatus stored in the memory matches a region code for a region where the utilization of the content is permitted with reference to a condition code for permitting content utilization included in condition information for permitting content utilization contained in the region code check program.

7. The apparatus according to claim 1, wherein the control unit determines whether or not the utilization of the content is permitted on the basis of a time limitation condition for content utilization with reference to the time limitation condition for content utilization included in condition information for permitting content utilization contained in the region code check program.

8. An information recording medium manufacturing apparatus, comprising:
content file creating means for creating a content file holding content to be recorded on an information recording medium;
content playback application file creating means for creating a content playback application file holding a content playback application program; and
recording means for recording the content file created by the content file creating means and the content playback application file created by the content playback application file creating means on the information recording medium, wherein
the content playback application file creating means creates the content playback application file holding a region code check program that causes execution of a determination operation of whether or not utilization of the content is permitted on the basis of a region code that is specific to a region and stored in an information processing apparatus that performs a content playback operation.

9. The apparatus according to claim 8, wherein the content playback application file creating means creates the content playback application file to which a digital signature for falsification detection is attached.

10. An information recording medium comprising:
content; and
a content playback application program for causing a playback operation of the content to be performed, wherein
the content playback application program contains a region code check program for causing execution of a determination operation of whether or not utilization of the content is permitted on the basis of a region code that is specific to a region and stored in an information processing apparatus that performs a content playback operation.

11. The medium according to claim 10, wherein the content playback application program is attached with a digital signature for falsification detection.

12. The medium according to claim 11, further comprising:
a public key certificate containing a public key used as a digital signature verification key.

13. An information processing method for an information processing apparatus that utilizes content recorded on an information recording medium, the method comprising the steps of:
obtaining a content playback application program that corresponds to the content recorded on the information recording medium and that is recorded on the information recording medium;
determining, by executing a region code check program contained in the obtained content playback application program, whether or not utilization of the content to be played back using the content playback application program is permitted on the basis of a region code that is a region-specific code corresponding to the information processing apparatus and that is obtained from a memory included in the information processing apparatus; and
performing a content playback operation using the content playback application program if the information processing apparatus is confirmed as the apparatus compliant with the region where the utilization of the content is permitted at the step of determining.

14. The method according to claim 13, wherein the step of obtaining the program includes obtaining a movie object recorded according to a Blu-ray Disc format as the content playback application program, and wherein
the step of determining includes executing the region code check program contained in the movie object.

15. The method according to claim 13, wherein the step of obtaining the program includes obtaining a Java® application program as the content playback application program, and wherein
the step of determining includes executing the region code check program contained in the obtained application program.

16. The method according to claim 13, further comprising the step of:
performing a signature verification operation on a digital signature attached to the content playback application program so as to confirm the validity of the content playback application program in the signature verification operation, wherein
the step of determining includes executing the region code check program if the validity of the content playback application program is confirmed in the signature verification operation.

17. The method according to claim 16, wherein the step of performing the signature verification operation includes performing the signature verification operation on the digital signature attached to the content playback application program using a public key obtained from a public key certificate recorded on the information recording medium.

18. The method according to claim 13, wherein the step of determining includes determining whether or not the region code corresponding to the information processing apparatus matches a region code for a region where the utilization of the content is permitted with reference to a condition code for permitting content utilization included in condition information for permitting content utilization contained in the region code check program.

19. The method according to claim 13, wherein the step of determining includes determining whether or not the utilization of the content is permitted on the basis of a time limitation condition for content utilization with reference to the time limitation condition for content utilization included in condition information for permitting content utilization contained in the region code check program.

20. An information recording medium manufacturing method comprising the steps of:
creating a content file holding content to be recorded on an information recording medium;
creating a content playback application file holding a content playback application program; and
recording the content file created at the step of creating the content file and the content playback application file created at the step of creating the content playback application file on the information recording medium, wherein
the step of creating the content playback application file includes creating the content playback application file holding a region code check program that causes execution of a determination operation of whether or not utilization of the content is permitted on the basis of a region code that is a region-specific code stored in an information processing apparatus that performs a content playback operation.

21. The method according to claim 20, wherein the step of creating the content playback application file includes creating the content playback application file to which a digital signature for falsification detection is attached.

22. A computer program causing an information processing apparatus to perform a utilization process of content recorded on an information recording medium, the process comprising the steps of:
obtaining a content playback application program that corresponds to the content recorded on the information recording medium and that is recorded on the information recording medium;
determining, by executing a region code check program contained in the obtained content playback application program, whether or not utilization of the content to be played back using the content playback application program is permitted on the basis of a region code that is a region-specific code corresponding to the information processing apparatus and that is obtained from a memory included in the information processing apparatus; and
performing a content playback operation using the content playback application program if the information processing apparatus is confirmed as the apparatus compliant with the region where the utilization of the content is permitted at the step of determining.

23. An information recording medium manufacturing apparatus, comprising:
a content file creating unit for creating a content file holding content to be recorded on an information recording medium;
a content playback application file creating unit for creating a content playback application file holding a content playback application program; and
a recording unit for recording the content file created by the content file creating unit and the content playback application file created by the content playback application file creating unit on the information recording medium, wherein
the content playback application file creating unit creates the content playback application file holding a region code check program that causes execution of a determination operation of whether or not utilization of the content is permitted on the basis of a region code that is specific to a region and stored in an information processing apparatus that performs a content playback operation.
